(19) United States
(12) Patent Application Publication
(10) Pub. No.: US 2005/0193341 A1
(43) Pub. Date: Sep. 1, 2005

(54) System for aggregating, processing and delivering video footage, documents, audio files and graphics

(76) Inventors: Anthony David Hayward, London (GB); Shoba Purushothaman, New York, NY (US); Matthew Alistair Fearon Thomson, Gloucestershire (GB); Sameer Mithal, New York, NY (US); Andy Hian Chong Toh, Singapore (SG); Krishnakumar Menon, New York, NY (US)

Correspondence Address: FISH & RICHARDSON, PC, 12390 EL CAMINO REAL, SAN DIEGO, CA, 92130-2081, US

(21) Appl. No.: 10/789,671

(22) Filed: Feb. 27, 2004

(51) Int. Cl. G06F 17/00; G06F 17/24; G06F 17/21; G06F 15/00; H04N 7/16; H04N 7/173; H04M 11/00

(52) U.S. Cl. 715/716; 715/500.1; 725/112; 725/135; 725/109; 715/501.1; 715/513; 715/514

(57) ABSTRACT

A technology platform that receives, organizes, aggregates, markets and distributes broadcast-standard (e.g., MPEG 2, MPEG 3, MPEG 4), high quality video footage (e.g., news clips) to the broadcast journalist industry. The platform includes a web site that presents an online archive and allows users, such as broadcast journalists, from around the world to find and download broadcast-standard video clips to use in their news and feature programs. The platform also manages and provides access to web-quality video, audio clips, high-resolution graphics, and textual news articles.

### BACKGROUND

Content providers have traditionally distributed news content to newsrooms, such as newsrooms at TV stations, by mailing videos tapes, photographs and audio files by mail or transmitting videos by satellite. Marketing, distributing and tracking this news content has been costly, time-consuming and labor-intensive.

### SUMMARY

A technology platform is disclosed that receives, organizes, aggregates, markets and distributes broadcast-standard (e.g., MPEG 2, MPEG 3, MPEG 4, etc.), high quality video footage (e.g., news clips) to the broadcast news industry. The platform may use any kind of link, such as without limitation, a network such as a LAN, WAN or the Internet, a telecommunications link, a wire or optical link or a wireless connection. The platform includes a web site that presents an online archive and allows users (e.g., broadcast journalists) from around the world to find and download broadcast-standard video clips to use in their news and feature programs. The platform also manages and provides access to web-quality video, audio clips, high-resolution graphics, and textual news articles.

Customers of the platform may include a broad spectrum of third party content creators, such as individuals, corporations, government agencies, and non-profit organizations who wish to distribute content to the broadcast media. These customers may provide their content free-of-cost and without copyright restrictions or with usage rights associated (price, usage restrictions, etc.) to end users (e.g., broadcast journalists) for use in their news programming. For these customers, the platform transforms an archaic, labor-intensive, low-tech process of content marketing, distribution and tracking into a fast, flexible, timely, cost-effective, technology-driven process. The platform drives down costs for these customers, as well as widens and deepens their content distribution. In addition, the platform allows greater return on investment (ROI) on content creation investments by the customers by extending the shelf-life and enabling re-use of existing content.

Some features of the platform include digitizing and tagging new analog or digital videos; making the videos accessible and searchable via an always-on, video-on-demand web-based platform; allowing a user to select a mode of content delivery; automated content request fulfillment process; and digital video delivery.

The platform may have a number of advantages, such as presenting a more reliable and scalable distribution alternative compared to satellite and tape-by-mail. The economics of the platform's digital distribution means customers can derive multiple use & re-distribute content over and over again for less than the one-time price tag of satellite and tape-by-mail. The platform uses a web-browser based service, which may allow any user with a connection to the World Wide Web to access the news videos. Aggregation of content from a broad spectrum attracts journalists looking for a rich archive of content and drives overall exposure and demand for customer content. By having a centralized gateway for global distribution, customers have unprecedented control on the content they distribute to the media.

One general aspect relates to a method that distributes broadcast standard video footage to a plurality of users. The method comprises receiving video footage from one or more content providers; processing the video footage to create a plurality of assets, each asset having a broadcast standard video footage and a preview version; providing a user interface that allows a plurality of users to (a) access a plurality of preview versions via a network connection and (b) request delivery of broadcast standard video footage; providing a plurality of delivery types for the broadcast standard video footage, the delivery types comprising at least three of a download via HyperText Transfer Protocol (HTTP), a digital push to a user-specified File Transfer Protocol (FTP) server location, a digital pull from a pre-determined FTP folder, a satellite transmission, and a mailing of physical media (e.g., tapes or DVDs) to the user; receiving a user request to obtain a broadcast standard video footage, the user request identifying the broadcast standard video footage and a delivery type selected from the plurality of delivery types; and fulfilling the user request. The pre-determined FTP folder may comprise an automatically created, user-specific and password protected FTP folder on a FTP server of a service provider.

Another general aspect relates to a system comprising a local media server, a content processing system, a central media server, a content manager application, a web server, and a fulfillment application. The content processing system receives video footage from one or more content providers. The content processing system is coupled to the local media server and processes the video footage and creates a plurality of assets. Each asset has a broadcast standard video footage and a preview version. The content processing system transfers the created assets to at least one of the central media server and the local media server. The central media server is in communication with the local media server and content processing system. The central media server is operable to store broadcast standard video footage. The content manager application is executable by a database server to manage the assets. The web server is coupled to the central media server to provide a web site that allows a plurality of users to (a) access a plurality of preview versions and (b) request delivery of broadcast standard video footage. The fulfillment application is executable by the database server to provide a plurality of delivery types for the broadcast standard video footage. The delivery types comprise at least three of the following: a download via HyperText Transfer Protocol (HTTP), a digital push to a user-specified File Transfer Protocol (FTP) server location, a digital pull from a pre-determined FTP folder, a satellite transmission, and a mailing of physical media (e.g., tapes (or DVDs) to the user. The fulfillment application is operable to process user requests and deliver broadcast standard video footage according to a delivery type in the user requests selected from the plurality of delivery types.

The details of one or more aspects are set forth in the accompanying drawings and the description below. Other features and advantages will be apparent from the description and drawings, and from the claims.

### BRIEF DESCRIPTION OF DRAWINGS

FIG. 1A illustrates three stakeholders of an Internet-based technology platform in FIGS. 1B and 1C.

FIG. 1B illustrates a web site infrastructure for the three stakeholders of FIG. 1A.

FIG. 1C illustrates a more detailed view of the infrastructure in FIG. 1B.

FIG. 1D illustrates a plurality of processes, which may include software modules, of the infrastructure in FIG. 1B.

FIG. 2A illustrates an overall workflow of the infrastructure in FIG. 1B.

FIG. 2B illustrates another workflow of the infrastructure in FIG. 1B.

FIG. 3 illustrates a content intake/ingestion workflow.

FIG. 4 illustrates a content presentation and approval workflow.

FIG. 5A illustrates a user registration process.

FIG. 5B is a table of user roles and corresponding privileges.

FIG. 6 illustrates a content access workflow.

FIG. 7 illustrates a content request process by user.

FIG. 8A illustrates an item fulfillment process.

FIG. 8B illustrates examples of delivery methods available for each asset type and format combination.

FIG. 8C illustrates a digital fulfillment process.

FIG. 8D illustrates a tape or satellite fulfillment process.

Like reference symbols in the various drawings indicate like elements.

### DETAILED DESCRIPTION

Stakeholders: Customer, ServiceProvider, and User

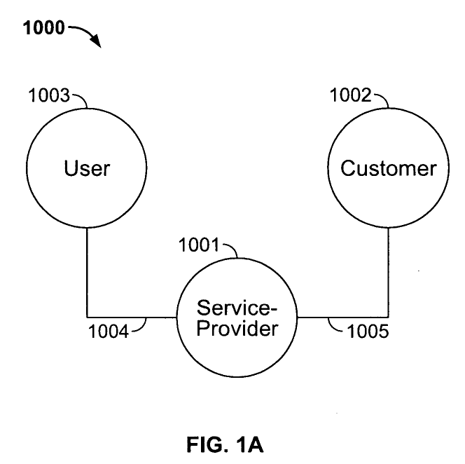

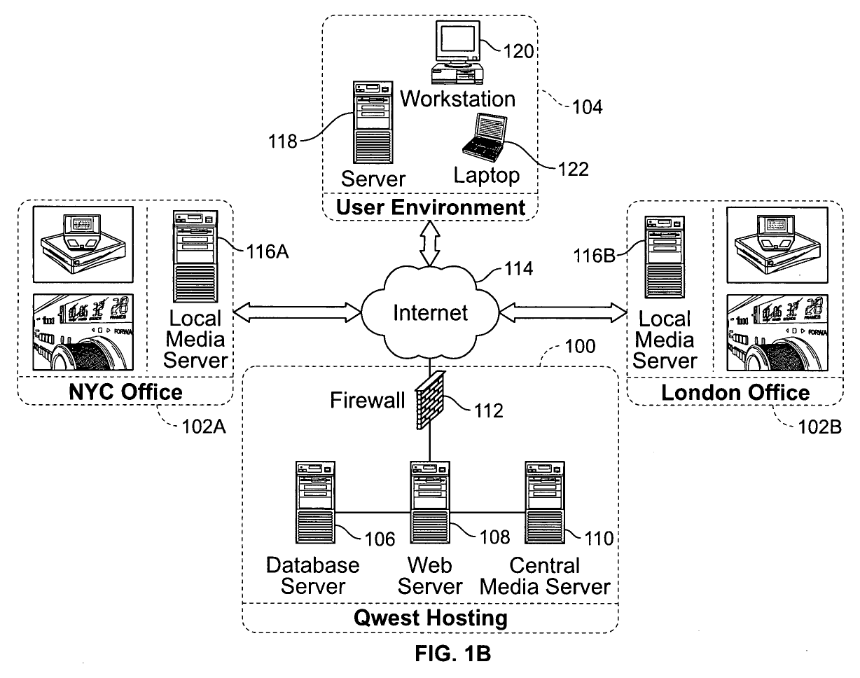

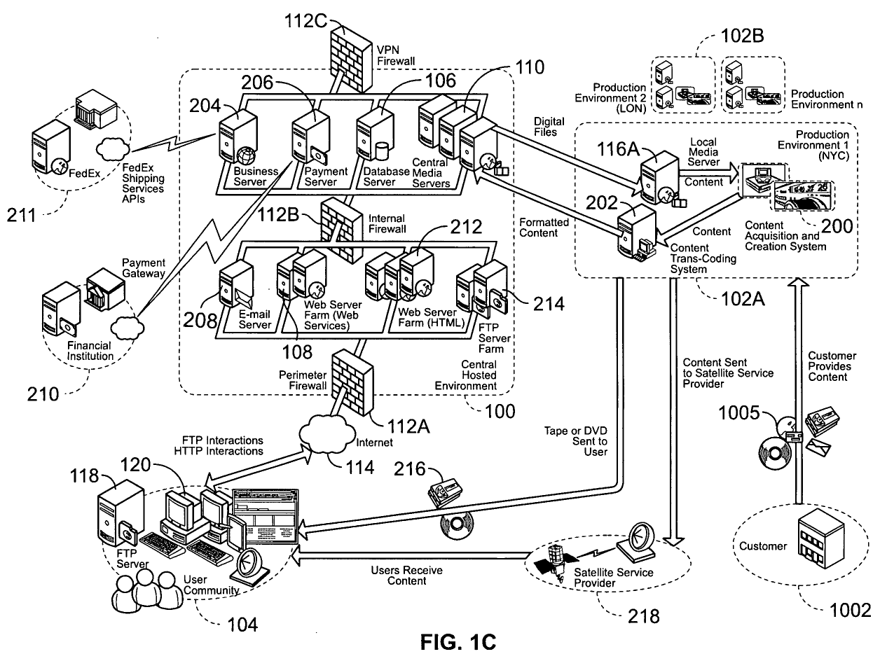

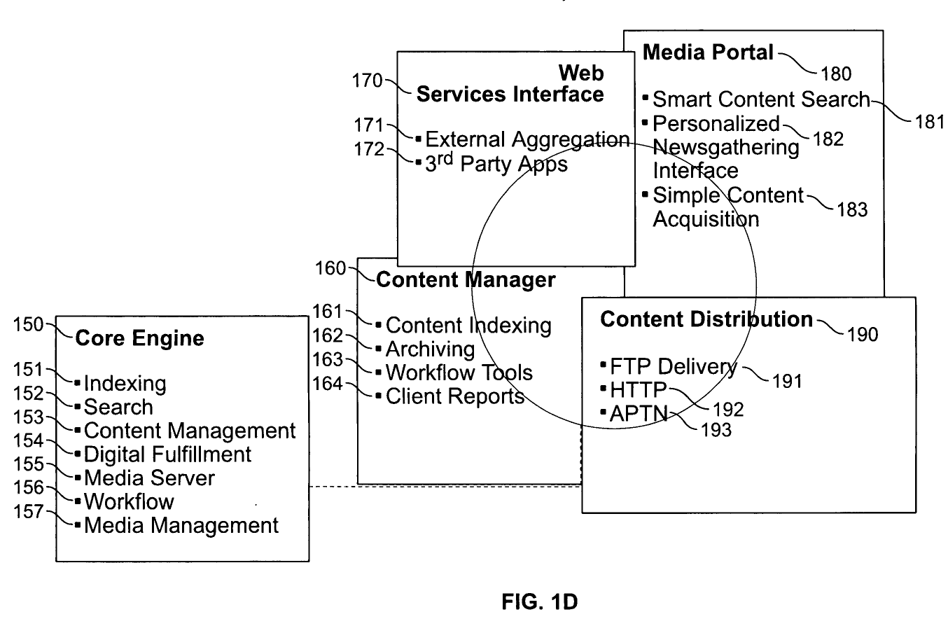

FIG. 1A illustrates three stakeholders 1001, 1002, 1003 of an Internet-based technology platform (FIGS. 1B and 1C), which receives, organizes, aggregates, markets and distributes broadcast-standard, high quality video footage. “Video footage” may be any length of video material (e.g., sequence of frames) and may include news events, new products, new services, background material, locations, cultural activities, sports, technology, automobiles, aerospace, defense, human interest, business, entertainment, government affairs, etc.

The “customer” 1002 represents any individual, company or organization that provides multimedia content to the service-provider 1001 for preview and access by a user 1003. The customer 1002 provides content 1005 to a service-provider 1001. The service-provider 1001 represents administrators, processes and automated systems, including but not limited to a web site.

The “user” 1003 represents any individual, company or organization who is registered with the service-provider 1001 to preview and access content presented by the service-provider 1001. The user 1003 contacts the service-provider 1001 to obtain content provided by a customer 1002. For example, the user 1003 may be a person who works with a media (e.g., television, radio, photo, print, including newspapers and magazines) organization (broadcast news community) who is responsible for gathering content for a specific media type. The user 1003 may be an operator, manager or administrator who manages the content for or on behalf of the service-provider 1001. The user 1003 may be a manager representing the customer 1002. The user 1003 registers with the service-provider 1001 to access and use the content 1004.

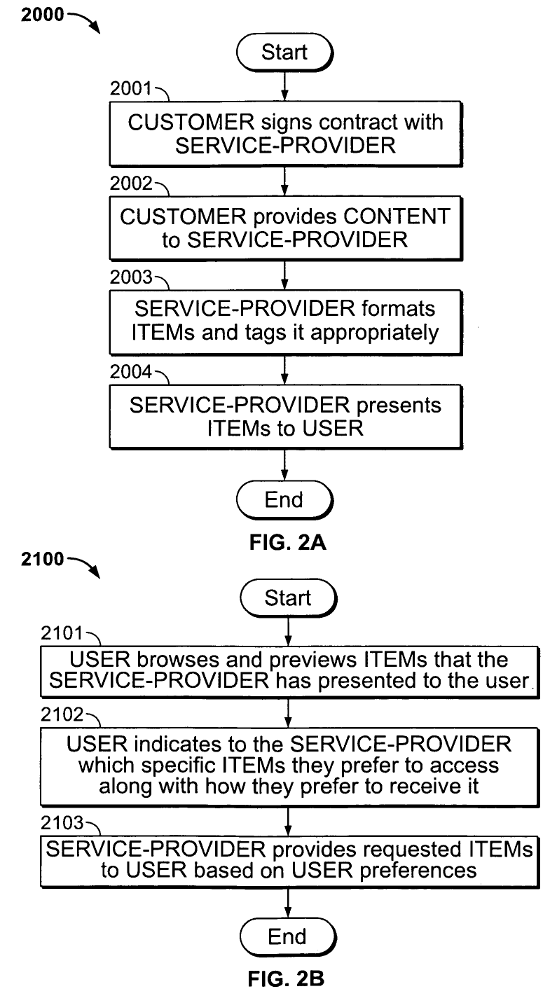

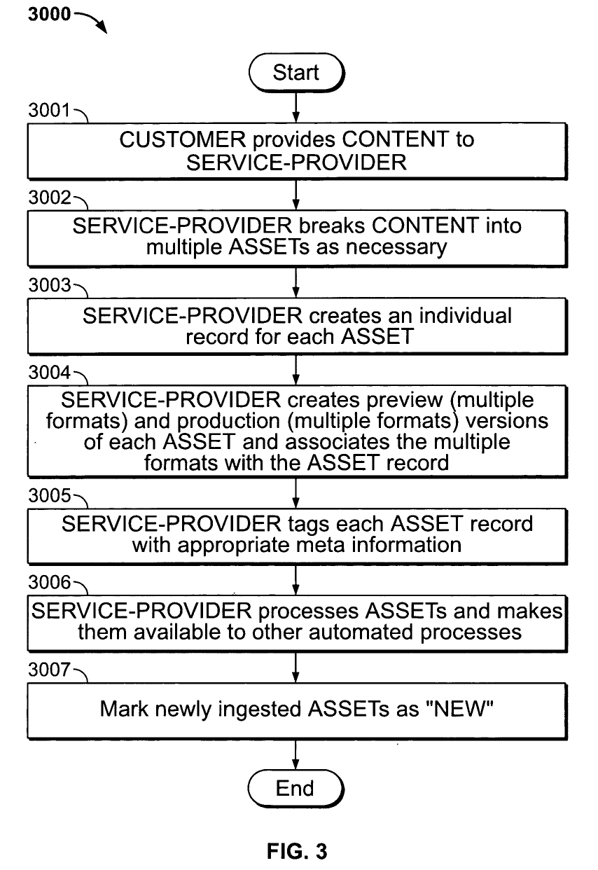

“Content” refers to multimedia materials (video, photo, document or audio) provided by the customer 1002 to the service provider 1001. “Content” broadly includes “assets” and “items.” The terms “content,” “asset” and “item” may be used interchangeably in the flowcharts described below (FIGS. 2A-8D).

An “asset” refers to content provided by the customer 1002 to the service provider 1001 and is processed (extracted, broken up, edited, etc.) by the service provider 1001. Every asset may be represented or tracked in the content management system 153 (FIG. 1D) of the service provider 1001 by a unique asset ID. An asset may have both a logical and a physical entity. An asset has a “type,” such as video, still (also called image), document and audio. Every asset has one or more digital file(s) associated to it. For example, a document asset may have an Adobe PDF and/or Microsoft Word document file. Similarly, a video asset may have multiple streaming format files (e.g., Microsoft Windows Media Video file, QuickTime format file, etc) and a broadcast standard video file (e.g., Motion Picture Experts Group MPEG2 or MPEG4).

“MPEG-1” may refer to a video resolution of 352-by-240 at 30 frames per second (fps). This produces video quality slightly below the quality of conventional VCR videos. MPEG-2 offers resolutions of 720×480 and 1280×720 at 60 fps with full CD-quality audio. This is sufficient for all the major TV standards, including NTSC, and even HDTV. “MPEG-2” is used by DVD-ROMs. MPEG-2 can compress a 2-hour video into a few gigabytes. “MPEG-3” was proposed for High Definition TV and has been incorporated into MPEG-2. “MPEG-4” is a graphics and video compression algorithm standard that is based on MPEG-1 and MPEG-2 and Apple QuickTime technology. Wavelet-based MPEG-4 files are smaller than JPEG or QuickTime files, so they are designed to transmit video and images over a narrower bandwidth and can mix video with text, graphics and 2-D and 3-D animation layers. MPEG-4 was standardized in October 1998 in the ISO/IEC document 14496.

An “item” refers to an asset of a particular type (e.g., video, document) of a particular format (MS Windows Media Video streaming file, QuickTime format streaming file, broadcast quality MPEG file, etc. for video type assets; Adobe PDF, MS Word document files, etc, for document type assets, etc.). An item is the most granular representation of content. An item could also be an analog version of content that can been created using existing digital items/assets. An example would be a document printed from the digital version of a digital document asset, or a Beta-SP tape created from digital video items/assets.

A “story” is a logical collection of relevant assets with an abstract. Stories can be described as editorial compilations of related media assets around a particular announcement or news story. By accessing/viewing a story, a user is presented with all assets needed to illustrate the story, either via video, or still images as well as all supporting documents around the story (e.g., shot lists, press releases). Every story is represented or tracked in the content management system 153 (FIG. 1D) of the service provider 1001 by a unique story ID. A story is purely a logical entity.

Infrastructure

FIG. 1B illustrates a web site infrastructure for the three stakeholders 1001, 1002, 1003 of FIG. 1A. The infrastructure includes a hosted server environment 100, production facilities 102A, 102B, and a user environment 104. Any number of hosted server environments, production facilities and user environments may be implemented. The service-provider may control or manage the hosted server environment 100 and production facilities 102A, 102B. The hosted server environment 100 may include a firewall 112, a web server 108, a database server 106 and a central media server 110. The production facilities 102A, 102B may include a local media server 116A, 116B and other components. The local-media-server 116 is a computer system that stores assets and may be located within the premises of a service-provider. The user environment 104 may include a server 118, a workstation 120 and/or a laptop 122 or any device or tool that allows access to the content hosted by the service provider. The user may control access information to access the FTP server 118.

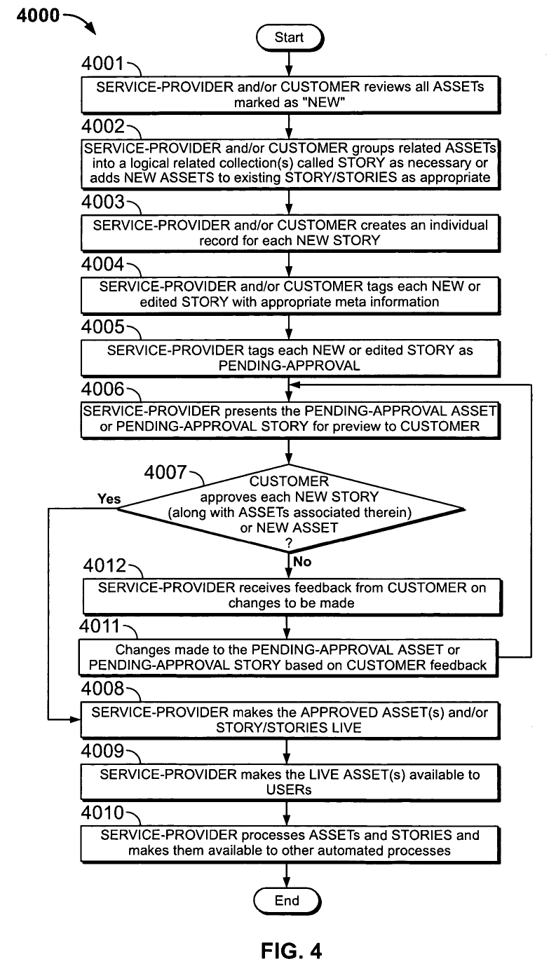

The production facilities 102A, 102B receive analog tapes or other forms of content (like DVD, CD, DV tape, see block 1005 in FIG. 1C) directly from customers (see FIGS. 2A and 3). These tapes are digitized, tagged with meta data, and transferred to the hosted server environment 100. All the digital media files may be stored on the central media server 110 in the hosted server environment 100.

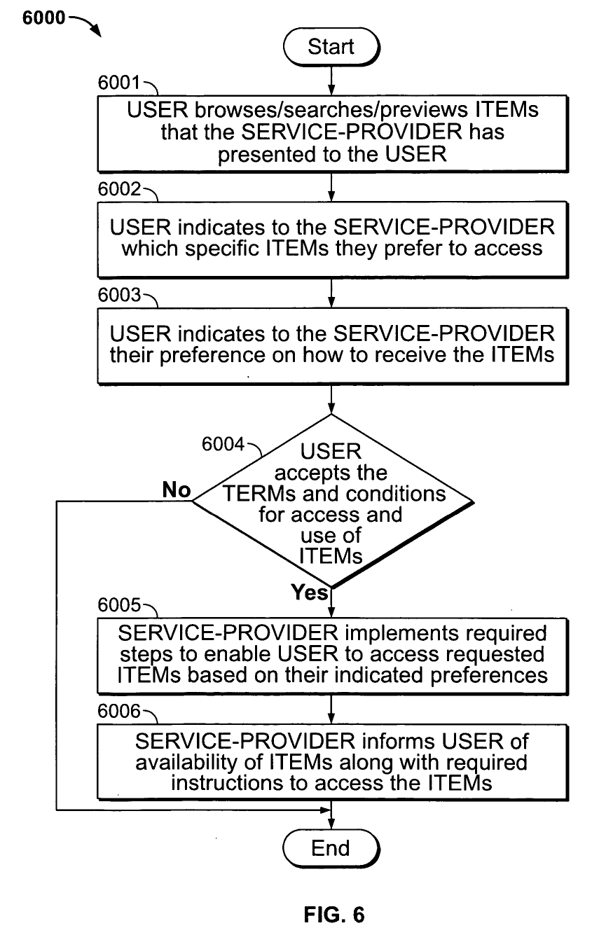

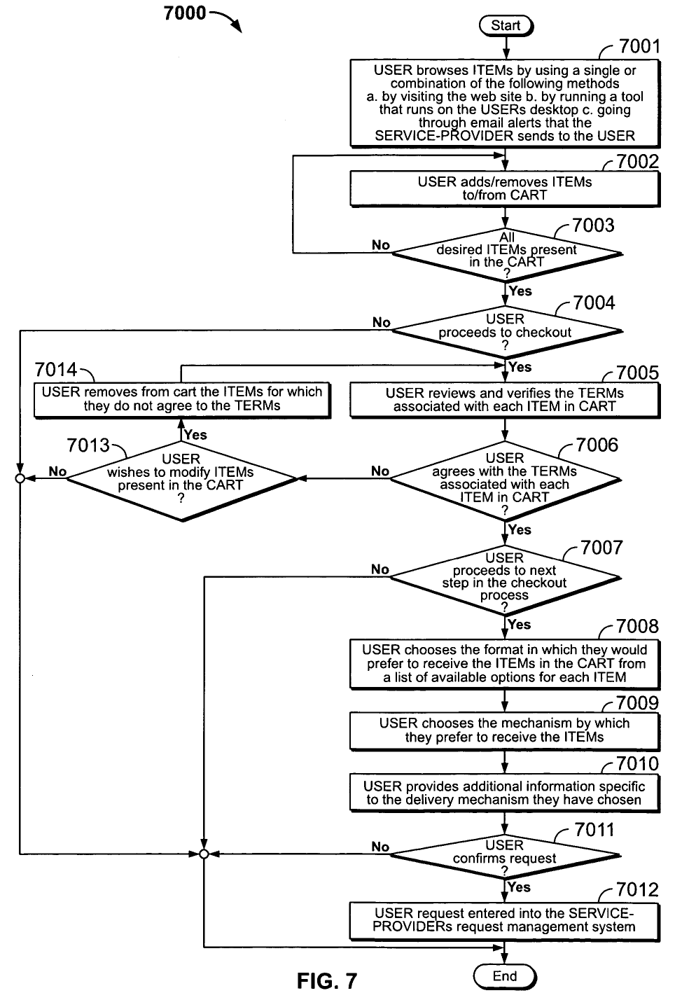

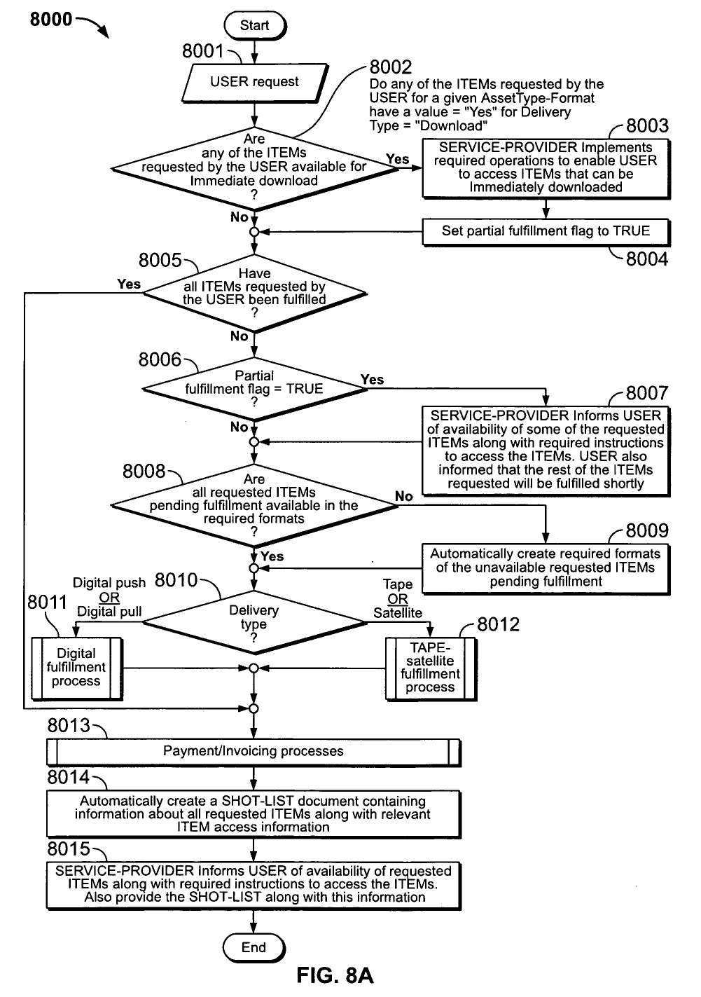

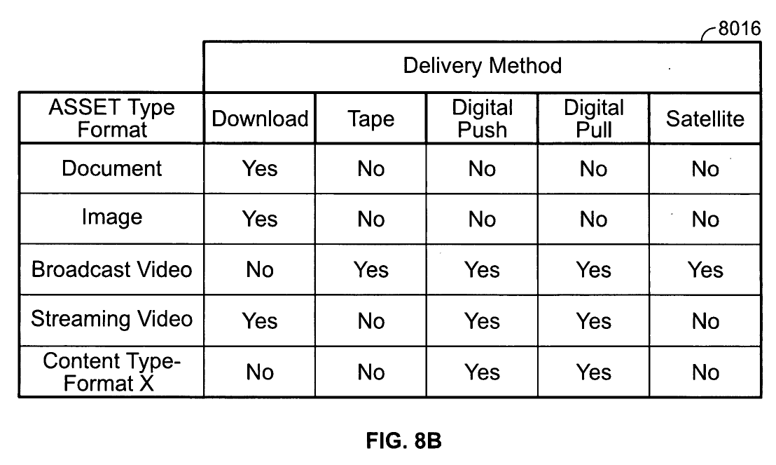

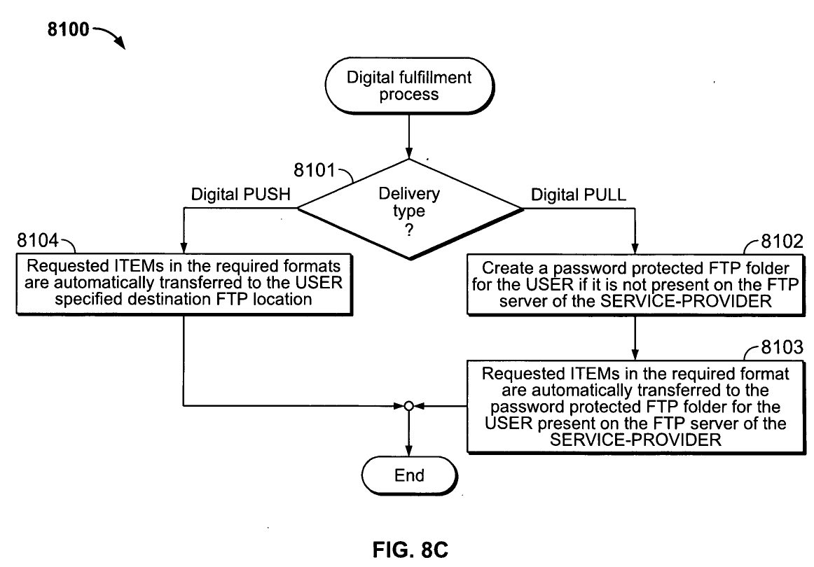

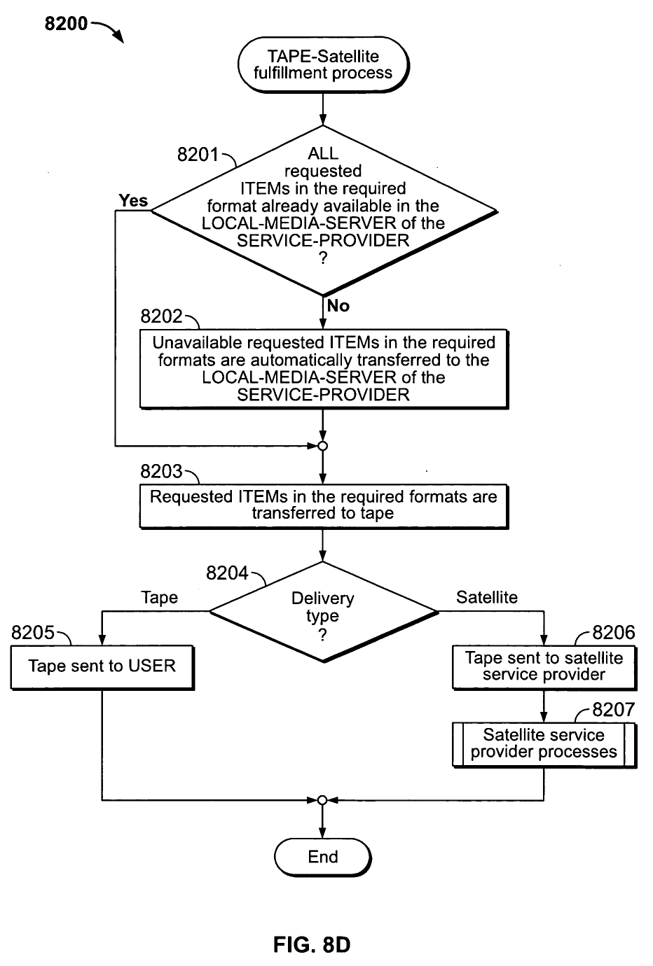

The end users at user environments 104 order content directly from a web site hosted by the hosted server environment 100 and also provide user preferences on how to receive the file assets they ordered (see FIGS. 6-7). A server application at the hosted server environment 100 then processes each individual order and moves digital files to the various destinations depending on the order detail (see FIGS. 8A-8D). The file destinations may be selected from one of the following: the hosted server environment 100, where end users can directly download the media files from the web server 108 onto their desktops 120 using the File Transfer Protocol (FTP) standard or HTTP; from the FTP server 214 in FIG. 1C onto their desktops 120 using the File Transfer Protocol (FTP); a user specified FTP server; or a production infrastructure at the production facilities 102A, 102B for processing tape orders.

FIG. 1C illustrates a more detailed view of the infrastructure in FIG. 1B. A customer 1002 provides content 1005 to the production facilities 102A, 102B. A content acquisition and creation system 200 (e.g., Beta decks, computers) processes the content. A content trans-coding system 202 trans-codes the content into desired digital formatted assets and transfers the assets to the central media servers 110 located in the central hosted infrastructure 100. For example, the content trans-coding system 202 may include Telestream ClipMail Pro to create MPEG files from Beta SP tape content and other inputs and Telestream FlipFactory to flip the MPEG files into .asf/.wmv (Windows Media Player) and .qt (Quick Time Player) and other desired formats like MPEG2 and MPEG4. The local media server 116A is used as part of the local production workflow and may be closely coupled to the central media server 110 in the central hosting environment 100 using FTP and Web Services.

The central hosted environment 100 may integrate various components and processes in an automated way. HyperText Markup Language (HTML) web servers 212 render dynamically generated HTML pages based on data which the web server applications receive from the business components on a business server 204 and user inputs. The HTML web servers 212 also provide access to streaming files, various image files and other data files for users to preview content. Web Services web servers 108 expose web services interfaces to support external web services based interfaces for: management of content by customers, administrators and managers; created tools for viewing and accessing content; interfaces to enable customer systems to integrate their workflow with the processes and content described herein. FTP servers 214 hosts FTP service and data to enable users to download items ordered through a Shopping Cart (described below). FTP servers 214 are used for the digital pull delivery. An email server 208 sends various notifications generated by the system to managers, administrators, users and customers.

A business server 204 hosts various business components, services and scheduled jobs to manage reporting, fulfillment, content management and notification. The business server 204 may also host components that interact with the FedEx Shipping Services APIs 211 (or any other APIs that integrate with other mail/shipping providers). A payment server 206 is an interface to a payment gateway. A database server 106 may host data desired and generated by the system, trigger background processes periodically or based on requests, and perform transactions triggered by business components on the business server 204 using stored procedures. The central media servers 110 host various formats of the digital files associated with the various assets managed by the system as a whole.

There may be one or more firewalls 112A-112C for the central hosted environment 100. The database server 106 and the central media server 110 may be protected using firewall rules and may also be on a separate virtual local area network (VLAN) for added security. Other components may be implemented instead of or in addition to the components shown in FIG. 1C.

A satellite service provider 218 transmits content to users 104. Alternatively, the service provider operating the central hosted environment 100 may operate its own satellite transmission system.

FIG. 1D illustrates a plurality of processes, which may include software applications, modules and engines, of the infrastructure in FIG. 1B. A core engine 150 may tie together several modules to create a powerful platform. An indexing module 151 manages all key content meta data to allow digital assets to be found efficiently. “Meta data” for an asset may include Asset Title, Asset Description, and Keywords (including company name). A search module 152 enables intelligent searches and may incorporate a thesaurus. A content management system 153 manages all digital content. A digital fulfillment engine 154 manages the delivery of broadcast quality video and other assets. A media server 155 allows the preview of videos (e.g., .mov, .wmv and .asf files). A workflow engine 156 enables a multi level process for the approval of content. A media management module 157 enables targeting and managing the registrations of media contacts around the world.

Interfaces and applications may be built on top of the core engine 150 to interact with users, customers and other applications. For example, a media portal 180 is an intuitive web based interface that allows users to search or browse for indexed content 181, preview digital content on the web, set personalized options 182, and order content 183.

As another example, a content distribution and fulfillment module 190 enables the user to access broadcast quality digital content using HyperText Transfer Protocol (HTTP) 192, File Transfer Protocol (FTP) 191 or Associated Press Television News (APTN) 193. The downloaded broadcast quality video (e.g., MPEG 2, MPEG 4 or variations) can be used by broadcast media personnel directly in their production rooms.

As another example, a content manager 160 is a backend web based interface that manages digital content throughout its lifecycle, including production, interchange, and also provides archiving, workflow and reporting functionality.

The infrastructure in FIG. 1C may use a code base built on the latest Microsoft NET platform. This allows the infrastructure to provide users and customers with web services interface, PDA enablement, advanced alerts, multiple language support, etc. The core engine application 150 may be built using VB.NET—for the various assemblies. The web services interface 170 may be built using ASP.NET (VB.NET can be the language of choice again). Web services 170 is used by the core engine application 150 to manage content between the hosted server environment 100 and the production facilities 102A, 102B.

Critical user information is encrypted and stored in the database server 106. This ensures that all critical user information is secure even at the database level. For example, the media portal 180 may use a 128-bit Secure Socket Layer (SSL) for user login and user profile management using a VeriSign digital certificate.

The managed server hosting environment 100 may provide 24 hour, 7 days a week monitoring of servers, a managed firewall 112 to control access to servers 106-110, redundant hard drives for all critical data, regular update of security patches on all servers, internal server access auditing, and regular full and incremental backups of our data. These features may ensure that that all critical data and servers are safe, secure and resistant to hardware failures.

Workflows

There are three major workflows or processes: (a) customer registration and content formation; (b) user registration and approval; and (c) asset request and fulfillment.

FIG. 2A illustrates an overall workflow 2000 of the infrastructure in FIG. 1B. A CUSTOMER signs a contract with a SERVICE-PROVIDER in 2001. The CUSTOMER provides CONTENT to the SERVICE-PROVIDER in 2002. The SERVICE-PROVIDER formats ITEMs from the CONTENT and tags the ITEMS appropriately in 2003. The SERVICE-PROVIDER presents the ITEMs to a USER in 2004.

FIG. 2B illustrates another workflow 2100 of the infrastructure in FIG. 11B. A USER browses and previews ITEMs that the SERVICE-PROVIDER has presented to the user in 2101. The USER indicates to the SERVICE-PROVIDER which specific ITEMs the USER prefers to access along with how the USER prefers to receive the ITEMs in 2102. The SERVICE-PROVIDER provides requested ITEMs to the USER based on the USER preferences in 2103.

Content Intake/Ingestion

FIG. 3 illustrates a content intake/ingestion workflow 3000. A CUSTOMER provides CONTENT (e.g., CD/DVD, tape, files via email) to the SERVICE-PROVIDER in 3001. The SERVICE-PROVIDER breaks the CONTENT into multiple ASSETs as desired in 3002. The SERVICE-PROVIDER creates an individual record (data file) for each ASSET in 3003. The SERVICE-PROVIDER creates preview (multiple formats) and production (multiple formats) versions of each ASSET and associates the multiple formats with the ASSET record in 3004. Examples of preview formats include Quick Time Player, Windows Media Player and Real Media Player. Examples of production formats include MPEG-1, MPEG-2, MPEG-3 and MPEG-4. The SERVICE-PROVIDER tags each ASSET record with appropriate meta information in 3005. The SERVICE-PROVIDER processes ASSETs and makes them available to other automated processes in 3006. The SERVICE-PROVIDER marks newly ingested ASSETs as “NEW” in 3007.

The SERVICE-PROVIDER may time code tapes received from a customer and establish a number of assets from the tape. Then the source tape is logged into the database server 106 or a media server 110 and a desired number of clips are generated. Then the clips are digitized with an asset ID. Then the digitized clips may be sent to the Flip Factory server 130 to be transcoded/converted to Windows Media (WMF) and Quick Time (QT) files. Once the content transcoding system processing is complete, the desired assets are transferred to the central hosted environment 100.

Content Presentation

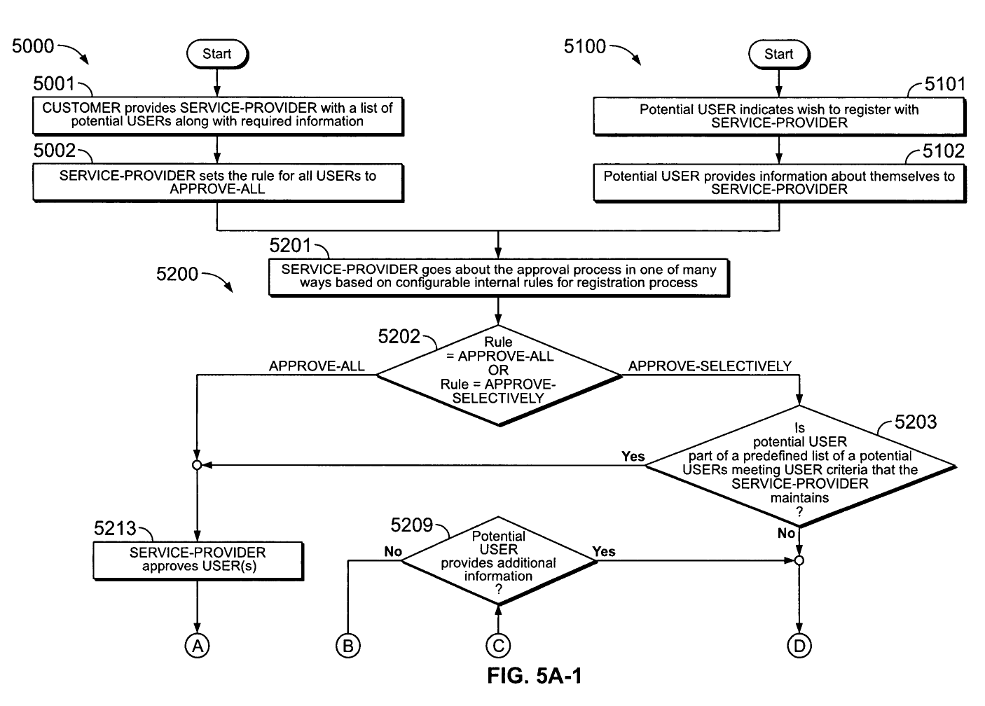

FIG. 4 illustrates a content presentation workflow 4000. The SERVICE-PROVIDER and/or CUSTOMER reviews all ASSETs marked as “NEW” in 4001. The SERVICE-PROVIDER and/or CUSTOMER groups related ASSETs into a logical related collection(s) called a “STORY” or adds NEW ASSETS to existing STORY/STORIES as appropriate in 4002. The SERVICE-PROVIDER and/or CUSTOMER creates an individual record (data file) for each NEW STORY in 4003. The SERVICE-PROVIDER and/or CUSTOMER tags each NEW or edited STORY with appropriate meta information in 4004. The SERVICE-PROVIDER tags each NEW or edited STORY as PENDING-APPROVAL in 4005. The SERVICE-PROVIDER presents the PENDING-APPROVAL ASSET or PENDING-APPROVAL STORY for preview to a CUSTOMER in 4006. The CUSTOMER approves each NEW STORY (along with ASSETs associated therein) or NEW ASSET in 4007. The SERVICE-PROVIDER receives feedback from CUSTOMER on changes to be made in 4012. Changes are made to the PENDING-APPROVAL ASSET or PENDING-APPROVAL STORY based on the CUSTOMER feedback in 4011. The SERVICE-PROVIDER makes the APPROVED ASSET(s) and/or STORY/STORIES LIVE in 4008. The SERVICE-PROVIDER makes the LIVE ASSET(s) available to USERs in 4009. The LIVE ASSET(s) may be organized into categories such as stories and “beats.” Examples of “beats” include Aerospace and Defense, Automotive and Transportation, Business and Industry, En Espafiol, Entertainment, Environment, Government-International Affairs, Healthcare, Human Interest, Locations, Public Service Announcements, Science and Technology, Sports and Leisure, and Trade Shows. The SERVICE-PROVIDER may also present ASSETS individually as in a library of individual ASSETS categorized by a BEAT or TYPE. The SERVICE-PROVIDER processes ASSETs and STORIES and make them available to other automated processes in 4010.

User Registration

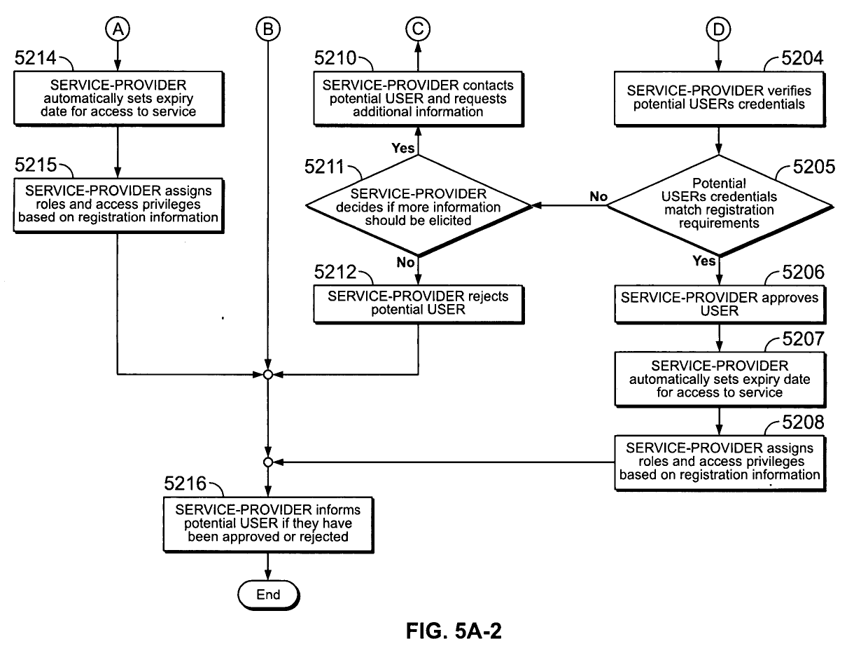

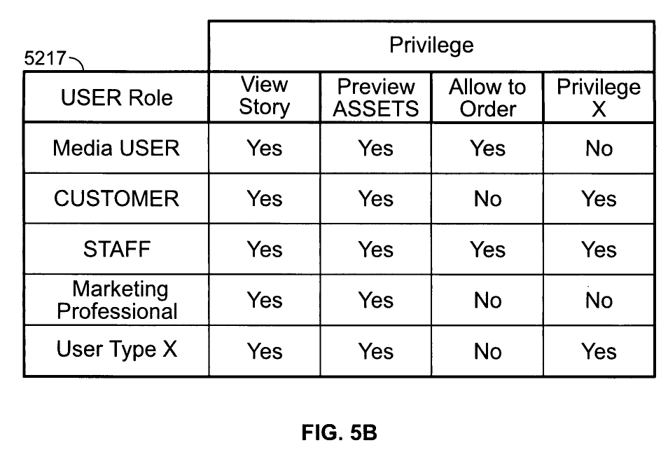

FIG. 5A illustrates a user registration process 5000, 5100 and 5200. A CUSTOMER may provide the SERVICE-PROVIDER with a list of potential USERs along with desired information in 5001. The SERVICE-PROVIDER sets the rule for all USERs to APPROVE-ALL in 5002. Alternatively, a potential USER indicates a desire to register with the SERVICE-PROVIDER in 5101. The potential USER provides information about themselves to the SERVICE-PROVIDER in 5102.

The SERVICE-PROVIDER initiates the approval process in one of many ways based on configurable internal rules for the registration process in 5201. The SERVICE-PROVIDER determines whether Rule=APPROVE-ALL or Rule=APPROVE-SELECTIVELY in 5202. The SERVICE-PROVIDER determines whether potential USER is part of a predefined list of a potential USERs meeting USER criteria that the SERVICE-PROVIDER maintains in 5203. The SERVICE-PROVIDER approves USER(s) in 5213. The SERVICE-PROVIDER automatically sets an expiration date for access to service in 5214. The SERVICE-PROVIDER assigns roles and access privileges based on registration information in 5215 (see FIG. 5B, which shows a list of access privileges that are automatically assigned based on the user type). The SERVICE-PROVIDER informs the potential USER if they have been approved or rejected in 5216.

The SERVICE-PROVIDER verifies potential USERs credentials in 5204. The SERVICE-PROVIDER determines whether potential USER credentials match registration requirements in 5205: If there is no match, the SERVICE-PROVIDER decides if more information should be elicited in 5211. If the SERVICE-PROVIDER decides that more information should be elicited, the SERVICE-PROVIDER contacts potential USER and requests additional information in 5210. The potential USER provides additional information in 5209. If the SERVICE-PROVIDER decides that more information should not be elicited in 5211, the SERVICE-PROVIDER rejects potential USER in 5212. The SERVICE-PROVIDER approves the USER in 5206. The SERVICE-PROVIDER automatically sets expiration date for access to service in 5207. The SERVICE-PROVIDER assigns roles and access privileges based on registration information in 5206.

FIG. 5B is a table 5217 of user roles and corresponding privileges. There are four user roles and three privileges shown as examples, but more user roles and more privileges may be implemented as shown by user type X and privilege X.

Content Access

FIG. 6 illustrates a content access workflow 6000. A USER browses, searches, and previews ITEMs that the SERVICE-PROVIDER has presented to the USER in 6001. The USER may use a standard web browser, such as Internet Explorer or Netscape, or some other tool that allows browsing, searching and requesting content, such as RSS news feed aggregator. The USER indicates to the SERVICE-PROVIDER which specific ITEMs they prefer to access in 6002. The USER indicates to the SERVICE-PROVIDER their preference on how to receive the ITEMs in 6003. The USER accepts the TERMs and conditions for access and use of ITEMs in 6004. “Terms” refer to conditions enumerated by the service-provider which the user agrees to prior to accessing and using any content/asset/item. Terms include (but not limited by) price, usage, rights etc. The SERVICE-PROVIDER implements processes to enable the USER to access requested ITEMs based on their indicated preferences in 6005. The SERVICE-PROVIDER informs USER of availability of ITEMs along with instructions to access the ITEMs in 6006.

Content Request

FIG. 7 illustrates a content request process 7000 by user. The USER browses ITEMs by one or more of the following methods: by visiting the web site; by running a tool that runs on the USER's desktop; going through email alerts that the SERVICE-PROVIDER sends to the USER in 7001; or using RSS content aggregator tools. The USER adds/removes ITEMs to/from CART in 7002. A “cart” is a virtual location of assets/items requested by user. The USER checks (e.g., by a prompt from the user interface or web site) whether all desired ITEMs are present in the CART in 7003. The USER proceeds to checkout in 7004. The USER reviews and verifies the TERMs associated with each ITEM in the CART in 7005. The USER removes the ITEMs that they do not agree to the TERMs from the CART in 7014. The user interface or web site may prompt the user to determine whether the USER wishes to modify ITEMS present in the CART in 7013. The USER may modify ITEMS present in the CART in 7013 if they desire. The SERVICE-PROVIDER determines whether the USER agrees with the TERMs associated with each ITEM in CART in 8006. The USER proceeds to a next step in the checkout process in 7007. The USER chooses the format in which they would prefer to receive the ITEMs in the CART from a list of available options for each ITEM in 7008. The USER chooses the mechanism by which they prefer to receive the ITEMs in 7009. The USER provides additional information specific to the delivery mechanism they have chosen in 7010. The USER confirms request in 7011. The USER request is entered into the SERVICE-PROVIDER's request management system in 7012.

Item Fulfillment

FIG. 8A illustrates an item fulfillment process 8000. A USER request is received in 8001. The SERVICE-PROVIDER determines whether there are any ITEMs requested by the USER available for immediate download, e.g., via HTTP, in 8002. Specifically, the SERVICE-PROVIDER determines whether there are any ITEMs requested by the USER for a given AssetType-Format having a value=“Yes” for Delivery Type=“Download.” If yes, the SERVICE-PROVIDER implements operations to enable the USER to access ITEMs that can be immediately downloaded in 8003. The system may create a temporary area where all requested content is stored, and a web server provides a conduit to this repository for access via HTTP. The SERVICE-PROVIDER sets Partial Fulfillment Flag to TRUE in 8004 if some items were made available for immediate download.

In some cases, the download mechanism may be in tandem with other delivery mechanisms to achieve efficiency and to enhance the user experience. Depending on various configurable rules and user choices (implicit or explicit), the system may enable all non-video assets (i.e. stills, audio, documents, etc.) to be downloaded immediately after checkout. The requested video content (if part of the user request) is then sent to the user via one of the other mechanisms described herein.

The SERVICE-PROVIDER determines whether all ITEMs requested by the USER have been fulfilled in 8005. The SERVICE-PROVIDER determines whether Partial Fulfillment Flag=TRUE in 8006. The SERVICE-PROVIDER informs the USER of availability of some of the requested ITEMs along with instructions to access the ITEMs in 8007. The USER is also informed that the rest of the ITEMs requested will be fulfilled shortly in 8007. The SERVICE-PROVIDER determines whether all requested ITEMs pending fulfillment are available in the desired formats in 8008. The SERVICE-PROVIDER automatically creates desired formats of the unavailable requested ITEMs pending fulfillment in 8009.

The SERVICE-PROVIDER determines a Delivery Type in 8010 selected by the USER. If the USER selected Digital Push or Digital Pull, then the SERVICE-PROVIDER follows a Digital Fulfillment Process in 8011 (FIG. 8C). If the USER selected TAPE or Satellite, then the SERVICE-PROVIDER follows a TAPE or Satellite Fulfillment Process in 8012 (FIG. 8D). Payment and invoicing processes, if any, may occur in 8013. The SERVICE-PROVIDER automatically creates a SHOT-LIST document containing information about all requested ITEMs in the USER order, along with relevant ITEM access information in 8014. A “shot-list” is a text description of content of one or more scenes or assets (e.g., a digital file or a printed document) in an order requested by a user. A shot-list may be automatically generated when an order is fulfilled. The SERVICE-PROVIDER informs the USER of availability of requested ITEMs along with instructions to access the ITEMs in 8015. The SERVICE-PROVIDER also provides the SHOT-LIST along with this information.

FIG. 8B illustrates examples of delivery methods 8015. One example of satellite is Associated Press Television News (APTN), which allows content to be multicasted into a number of locations. The service provider may provide specific content during a specific time slot to one or more users. Other content types may be implemented as shown by content type X, and other delivery types may be used, such as mailing DVDs.

FIG. 8C illustrates a Digital Fulfillment Process 8100. The SERVICE-PROVIDER determines a Delivery Type in 8101. If the delivery type is a digital pull, the SERVICE-PROVIDER creates a password protected FTP folder for the USER if it is not present on the FTP server 214 of the SERVICE-PROVIDER in 8102. Requested ITEMs in the desired format are automatically transferred to the password protected FTP folder for the USER present on the FTP server of the SERVICE-PROVIDER in 8103. The SERVICE-PROVIDER may allocate a memory portion of the FTP server to the requesting user. The SERVICE-PROVIDER may transmit access information to the requesting user, which permits the requesting user to access the memory portion so that the requesting user can obtain one or more selected assets. If the delivery type is a digital push, requested ITEMs in the selected formats are automatically transferred to the USER-specified destination FTP location (server 118 in FIG. 1C, which is part of the user's environment) in 8104. The system may send a notification to the user with details on how to access the content. Digital delivery requests may be checked to see if they have been fulfilled, e.g., by internal double-checking at the SERVICE-PROVIDER or by sending emails to the user.

FIG. 8D illustrates a TAPE or Satellite Fulfillment Process 8200. The SERVICE-PROVIDER checks whether ALL requested ITEMs in the selected format are already available in the LOCAL-MEDIA-SERVER of the SERVICE-PROVIDER in 8201. If not, unavailable requested ITEMs in the desired formats are automatically transferred to the LOCAL-MEDIA-SERVER of the SERVICE-PROVIDER in 8202. Requested ITEMs in the desired formats are compiled using files on the local media server and transferred to tape in 8203. Delivery Type is determined in 8204. If satellite is selected, a tape is sent to a satellite service provider in 8206. The satellite service provider 218 in FIG. 1C processes the tape and delivers the ITEMs, e.g., via satellite (e.g., APTN), in 8207. The system may send a notification to the user with details on how to receive/access the content. If tape is selected, then tape is sent to the USER, e.g., via FedEx, in 8205.

Other delivery methods may be used, such as compiling requested content on a CD or DVD using files present on the service provider's local media server, and then sending the CD or DVD with the items to the user.

A “module” is software, a portion of software, hardware, or a combination of hardware and software.

The service provider may receive a preference description from a user of one or more delivery options. The preference description may include supplemental information for the service provider to transmit assets to the first user according to said one or more delivery options of the preference description. The service provider may allow the user to change the preference description. The supplemental information may comprise a first user's mailing address. The supplemental information may comprise access information for an FTP server controlled by the first user.

The service provider may assign assets to one or more categories, receive an identification of one or more categories of interest from a user; and send to the user an email message or email alert that identifies specific assets within one or more identified categories. The email message may include a hyperlink to a web page that describes specifically identified assets and permits the first user to preview previewable versions of the specifically identified assets, select assets, and request delivery of selected, specifically identified assets. The web page may include a text description of the specifically identified assets. The email message may include a text description of the specifically identified assets.

A number of aspects have been described. Nevertheless, it will be understood that various modifications may be made. Accordingly, other aspects are within the scope of the following claims.

1. A method of distributing broadcast standard video footage to a plurality of users, the method comprising:
receiving video footage from one or more content providers;
processing the video footage to create a plurality of assets, each asset having a broadcast standard video footage and a preview version;
providing a user interface that allows a plurality of users to (a) access a plurality of preview versions via a network connection and (b) request delivery of broadcast standard video footage;
providing a plurality of delivery types for the broadcast standard video footage, the delivery types comprising at least three of a download via HyperText Transfer Protocol (HTTP), a digital push to a user-specified File Transfer Protocol (FTP) server location, a digital pull from a pre-determined FTP folder, a satellite transmission, and a mailing of physical media to the user;
receiving a user request to obtain a broadcast standard video footage, the user request identifying the broadcast standard video footage and a delivery type selected from the plurality of delivery types; and
fulfilling the user request.

2. The method of claim 1, wherein fulfilling the user request is performed automatically by computers.

3. The method of claim 1, wherein the user interface is a web site, and the network connection is an Internet connection.

4. The method of claim 1, wherein the broadcast standard video footage comprise Motion Picture Experts Group (MPEG)-2 files.

5. The method of claim 1, wherein the broadcast standard video footage comprise MPEG-4 files.

6. The method of claim 1, further comprising presenting snapshots of the preview versions in a plurality of categories on the user interface.

7. The method of claim 1, further comprising organizing assets into a plurality of stories for display on the user interface.

8. The method of claim 1, further comprising:
separating the video footage received from the content providers into a plurality of assets;
creating an asset record for each asset;
creating a preview version and a production version for each asset, the preview version and production version being selected from a plurality of formats; and
associating the selected formats with the asset record.

9. The method of claim 8, further comprising tagging each asset record with meta data.

10. The method of claim 8, further comprising making each asset available to an automated software process.

11. The method of claim 1, further comprising:
time coding an analog tape received from a content provider;
establishing a plurality of assets from the tape;
logging the tape into a media server;
generating a plurality of clips from the tape;
digitizing the clips with an asset ID; and
converting the digitized clips to a media player format comprising at least one of Windows Media File (WMF), Quick Time (QT) and Real Player.

12. The method of claim 1, further comprising:
registering a plurality of users by collecting information from each user; and
comparing the collected information with a database of broadcast media contact information.

13. The method of claim 1, further comprising creating a password protected FTP folder for a user for the digital pull delivery type.

14. The method of claim 1, further comprising presenting at least one of audio files, image files and text files associated with the broadcast standard video footage to the users on the user interface.

15. The method of claim 14, further comprising delivering at least one of the audio files, image files and text files associated with the broadcast standard video footage to the users.

16. The method of claim 14, further comprising organizing assets into a story to display on the user interface, each story comprising a broadcast standard video footage and at least one of an audio file, image file and text file associated with the broadcast standard video footage.

17. The method of claim 14, further comprising providing preview and production versions of at least one of the audio files, image files and text files.

18. The method of claim 17, wherein a preview version of an image has a resolution of X dots per inch and a production version of the image has a resolution of Y dots per inch, X being smaller than Y.

19. The method of claim 1, further comprising trans-coding the video footage into digital formatted assets.

20. The method of claim 1, wherein the satellite transmission uses a Associated Press Television News (APTN) system.

21. The method of claim 1, wherein the video footage from the content providers comprise at least one of analog tapes, digital tapes, satellite transmissions, DVDs and digital files.

22. The method of claim 1, wherein the pre-determined FTP folder comprises an automatically created, user-specific, password protected FTP folder on a FTP server of a service provider.

23. The method of claim 1, further comprising:
compiling two or more broadcast standard video footages requested by a user into a compilation; and
delivering the compilation to the user.

24. The method of claim 23, wherein the compilation comprises a single digital file.

25. The method of claim 23, wherein the compilation comprises a single physical medium delivered to the user.

26. A system comprising:
a local media server;
a content processing system coupled to the local media server to receive video footage from one or more content providers, process the video footage and create a plurality of assets, each asset having a broadcast standard video footage and a preview version, the content processing system transferring the created assets to at least one of the local media server and a central media server;
a central media server in communication with the local media server and content processing system, the central media server being operable to store broadcast standard video footage;
a content manager application executable by a database server to manage the assets;
a web server coupled to the central media server to provide a web site that allows a plurality of users to (a) access a plurality of preview versions and (b) request delivery of broadcast standard video footage; and
a fulfillment application executable by the database server to provide a plurality of delivery types for the broadcast standard video footage, the delivery types comprising at least three of a download via HyperText Transfer Protocol (HTTP), a digital push to a user-specified File Transfer Protocol (FTP) server location, a digital pull from a pre-determined FTP folder, a satellite transmission, and a mailing of physical media to the user;
wherein the fulfillment application is operable to process user requests and deliver broadcast standard video footage according to a delivery type in the user requests selected from the plurality of delivery types.

27. The system of claim 26, wherein the broadcast standard video footage comprise Motion Picture Experts Group (MPEG)-2 files.

28. The system of claim 26, wherein the broadcast standard video footage comprise Motion Picture Experts Group (MPEG)-4 files.

29. The system of claim 26, further comprising a File Transfer Protocol (FTP) server in communication with the database server and the central media server to deliver digital broadcast standard video footage to users.

30. The system of claim 26, wherein the content processing system comprises a trans-coding system to trans-code the video footage into digital formatted assets.

31. The system of claim 26, further comprising firewalls and user passwords to protect data in the central media server.

32. The system of claim 26, further comprising a second local media server in a second production office separate from a first production office of the first local media server.

33. A method of providing media assets to users over a network, the method comprising:
receiving media content from content providers;
creating assets with previewable versions from said content;
providing an interactive interface that allows a plurality of users to preview said previewable versions of said assets, select assets, and request delivery of selected assets;
receiving a request from a requesting user to deliver one or more selected assets; and
transmitting said selected assets to a File Transfer Protocol (FTP) server identified by said requesting user.

34. The method of claim 33, wherein the assets comprise Motion Picture Experts Group (MPEG) files.

35. The method of claim 33, wherein said requesting user controls access to said FTP server, the method further comprising:
receiving access information for said FTP server from said requesting user; and
using said access information to access said FTP server.

36. The method of claim 33, further comprising:
controlling user access to said FTP server;
allocating a memory portion of said FTP server to said requesting user;
transmitting access information to said requesting user, said access information permitting said requesting user to access said memory portion so that said requesting user can obtain said one or more selected assets.

37. The method of claim 33, wherein said assets comprise one or more of video, images, audio, text, and an integrated combination thereof.

38. A system for providing media assets to users over a network, the system comprising:
one or more cooperating servers configured to store broadcast-standard digitized versions of media assets, said one or more servers also configured to store previewable digitized versions of at least some of said media assets;
a user interaction module executable by said one or more servers, said user interaction module configured to communicate over the network with a communication module on a user computer to provide an interactive interface on the user computer, the interactive interface allowing a user of the user computer to preview said previewable versions of said assets, select assets, and request delivery of said broadcast-standard versions of said selected assets, said user interaction module configured to receive a request from the user to deliver one or more broadcast-standard versions of said selected assets to the user; and
a fulfillment module stored on said one or more servers, said fulfillment module configured to transmit said broadcast-standard versions of said selected assets to a File Transfer Protocol (FTP) server identified by the user.

39. The system of claim 38, wherein the FTP server is controlled by the user, the user interaction module being configured to receive access information for said FTP server from the user and to use the access information to access said FTP server.

40. The system of claim 38, wherein access to the FTP server is controlled by said one or more servers, the fulfillment module being configured to allocate a memory portion of the FTP server to the user and transmit access information to the user, the access information permitting the user to access the memory portion so that the user can obtain said broadcast-standard versions of said selected assets.

41. The system of claim 38, wherein the communication module on the user computer comprises a web browser.

42. The system of claim 38, wherein the communication module on the user computer comprises a software application on a user desktop.

43. A method of providing media assets to users via a satellite transmission, the method comprising:
receiving media content from content providers;
creating assets with previewable versions from said content;
providing an interactive interface that allows users to preview said previewable versions of said assets, select assets, and request delivery of said selected assets;
receiving a request from a requesting user to deliver one or more selected assets; and
provisioning a satellite transmission of said selected assets to said requesting user.

44. The method of claim 43, further comprising informing said requesting user of a time and reception channel at which said one or more selected assets will be transmitted.

45. A system for providing media content to users via a satellite transmission, the system comprising:
one or more cooperating servers configured to store broadcast-standard digitized versions of media assets, said one or more servers also configured to store previewable digitized versions of at least some of said media assets;
a user interaction module executable by said one or more servers, said user interaction module configured to communicate over the network with a communication module on a user computer to provide an interactive interface on the user computer, the interactive interface allowing a user of the user computer to preview said previewable versions of said assets, select assets, and request delivery of said broadcast-standard versions of said selected assets, said user interaction module configured to receive a request from the user to deliver one or more broadcast-standard versions of said selected assets to the user; and
a satellite transmission system configured to transmit said broadcast-standard versions of said selected assets to the user.

46. A method of providing media assets to users over a network, the method comprising:
receiving media content from content providers;
creating assets with previewable versions from said content;
providing an interactive interface that allows users to preview said previewable versions of said assets, select assets, and request delivery of said assets;
providing at least three options for delivery of said selected assets:
transmitting selected assets to a user-controlled File Transfer Protocol (FTP) server;
transmitting selected assets to an FTP server controlled by a service provider and sending access information to a requesting user, said access information permitting the requesting user to obtain said transmitted assets from the FTP server;
downloading selected assets via an HTTP protocol to a user-controlled computer;
provisioning a satellite transmission of selected assets to a requesting user; and
mailing physical media containing said selected assets to a requesting user;
receiving a request from a requesting user to deliver one or more selected assets, the request identifying at least one of said delivery options; and
transmitting said one or more selected assets to said requesting user by the one or more identified delivery options.

47. A system for providing media assets to users over a network, the system comprising:
one or more cooperating servers configured to store broadcast-standard digitized versions of media assets, said one or more servers also configured to store previewable digitized versions of at least some of said media assets;
a user interaction module executable by said one or more servers, said user interaction module configured to communicate over the network with a communication module on a user computer to provide an interactive interface on the user computer, the interactive interface allowing a user of the user computer to preview said previewable versions of said assets, select assets, and request delivery of said broadcast-standard versions of said selected assets, said user interaction module configured to receive a request from the user to deliver one or more broadcast-standard versions of said selected assets to the user; and
a fulfillment module stored on said one or more servers, said fulfillment module configured to execute one or more options for delivery of said broadcast-standard versions of said selected assets:
transmitting said broadcast-standard versions of said selected assets to a user-controlled File Transfer Protocol (FTP) server;
transmitting said broadcast-standard versions of said selected assets to an FTP server controlled by the one or more servers, the fulfillment module also configured to send access information to a requesting user, said access information permitting a requesting user to access the transmitted assets from the FTP server;
downloading said broadcast-standard versions of said selected assets via an HTTP protocol to a user-controlled computer;
provisioning a satellite transmission of said broadcast-standard versions of said selected assets to a requesting user; and
mailing physical media containing said broadcast-standard versions of said selected assets to a requesting user;
wherein the user interaction module is configured to receive a request from the user to deliver one or more of said broadcast-standard versions of said selected assets, the request identifying one or more of the above-listed delivery options, the fulfillment module configured to transmit said one or more broadcast-standard versions of said selected assets to the user by said one or more identified delivery options.

48. A method of providing media assets to users over a network, the method comprising:
receiving media content from content providers;
creating assets with previewable versions from said content;
providing an interactive interface that allows users to preview said previewable versions of said assets, select assets, and request delivery of said assets;
providing at least three options for delivery of said selected assets:
transmitting selected assets to a user-controlled File Transfer Protocol (FTP) server;
controlling an FTP server and transmitting selected assets to the FTP server and sending access information to a requesting user, said access information permitting the requesting user to obtain said transmitted assets to the FTP server;
downloading selected assets via an HTTP protocol to a user-controlled computer;
provisioning a satellite transmission of selected assets to a requesting user; and
mailing physical media containing said selected assets to a requesting user;
receiving from a first user a preference description of one or more of said delivery options, said preference description including supplemental information for the service provider to transmit assets to the first user according to said one or more delivery options of the preference description;
receiving a request from the first user to deliver one or more selected assets; and
transmitting said one or more selected assets to said first user according to said one or more delivery options of the preference description.

49. The method of claim 48, further comprising allowing the user to change the preference description.

50. The method of claim 48, wherein said supplemental information comprises said first user's mailing address.

51. The method of claim 48, wherein said supplemental information comprises access information for an FTP server controlled by said first user.

52. A system for providing media assets to users over a network, the system comprising:
one or more cooperating servers configured to store broadcast-standard digitized versions of media assets, said one or more servers also configured to store previewable digitized versions of at least some of said media assets;
a user interaction module executable by said one or more servers, said user interaction module configured to communicate over the network with a communication module on a user computer to provide an interactive interface on the user computer, the interactive interface allowing a user of the remote user computer to preview said previewable versions of said assets, select assets, and request delivery of said broadcast-standard versions of said selected assets, said user interaction module configured to receive a request from the user to deliver one or more broadcast-standard versions of said selected assets to the user; and
a fulfillment module stored on said one or more servers, said fulfillment module configured to execute one or more options for delivery of said broadcast-standard versions of said selected assets:
transmitting said broadcast-standard versions of said selected assets to a user-controlled File Transfer Protocol (FTP) server;
transmitting said broadcast-standard versions of said selected assets to an FTP server controlled by the one or more servers, the fulfillment module also configured to send access information to a requesting user, said access information permitting a requesting user to access the transmitted assets from the FTP server;
downloading said broadcast-standard versions of said selected assets via an HTTP protocol to a user-controlled computer;
provisioning a satellite transmission of said broadcast-standard versions of said selected assets to a requesting user; and
mailing physical media containing said broadcast-standard versions of said selected assets to a requesting user;
wherein the user interaction module is configured to receive from a first user a preference description of one or more of said delivery options, said preference description including supplemental information for the fulfillment module to execute the transmission of said broadcast-standard versions of said selected assets to the first user according to said one or more delivery options of the preference description, the user interaction module also configured to receive a request from the first user to deliver one or more broadcast-standard versions of said selected assets, the fulfillment module configured to execute the transmission of said one or more broadcast-standard versions of said selected assets to said first user according to said one or more delivery options of the preference description.

53. A method of providing media assets to users over a network, the method comprising:
receiving media content from content providers;
creating assets with previewable versions from said content;
assigning each of said assets to one or more of a plurality of categories;
receiving an identification of one or more categories of interest from a first user;
sending to said first user an email message that identifies specific assets within said one or more identified categories, said email message including a hyperlink to a web page that describes said specifically identified assets and permits said first user to preview previewable versions of said specifically identified assets, select assets, and request delivery of said selected, specifically identified assets;
receiving a request from said first user for delivery of said selected, specifically identified assets; and
transmitting said selected, specifically identified assets to said first user.

54. The method of claim 53, wherein said web page includes a text description of the specifically identified assets.

55. The method of claim 53, wherein the email message includes a text description of the specifically identified assets.

56. The method of claim 55, wherein one or more of the specifically identified assets comprise video segments and the text description describes a plurality of individual scenes in said video segments.

57. A system for providing media assets to users over a network, the system comprising:
one or more cooperating servers configured to store broadcast-standard digitized versions of media assets, said one or more servers also configured to store previewable digitized versions of at least some of said media assets;
a content manager module configured to assign each of said assets to one or more of a plurality of categories;
a user interaction module executable by said one or more servers, said user interaction module configured to communicate over the network with a communication module on a user computer to provide an interactive interface on the user computer, the interactive interface allowing a user of the user computer to transmit to said user interaction module an identification of one or more categories of interest;
a messaging module configured to send to said user an email message that identifies specific assets within said one or more identified categories, said email message including a hyperlink to a web page that describes said specifically identified assets and permits said user to preview previewable versions of said specifically identified assets, select assets and request delivery of selected, specifically identified assets, the web page configured to receive a request from said user for said selected, specifically identified assets; and
a fulfillment module configured to transmit said selected, specifically identified assets to said user.

58. A method of providing media assets to users over a network, the method comprising:
receiving video content from content providers;
creating video assets with previewable versions from said content;
providing an interactive interface that allows users to preview said previewable versions of said video assets, select video assets, and request delivery of said selected video assets;
receiving a request from a requesting user to deliver one or more selected video assets;
transmitting said selected video assets to said requesting user; and
transmitting to said requesting user text descriptions of a plurality of scenes in said selected video assets.

59. A system for providing media assets to users over a network, the system comprising:
one or more cooperating servers configured to store broadcast-standard digitized versions of video assets, said one or more servers also configured to store previewable digitized versions of said video assets;
a user interaction module executable by said one or more servers, said user interaction module configured to communicate over the network with a communication module on a user computer to provide an interactive interface on the user computer, the interactive interface allowing a user of the user computer to preview said previewable versions of said video assets, select video assets, and request delivery of said broadcast-standard versions of said selected video assets, said user interaction module configured to receive a request from the user to deliver one or more broadcast-standard versions of said selected video assets to the user; and
a fulfillment module stored on said one or more servers, said fulfillment module configured to transmit said broadcast-standard versions of said selected video assets to the user, the fulfillment module also configured to transmit to the user text descriptions of a plurality of scenes in said broadcast-quality versions of said selected video assets.
